(19) United States
(12) Patent Application Publication
(10) Pub. No.: US 2016/0327628 A1
(43) Pub. Date: Nov. 10, 2016

(54) Method And Apparatus For Determining Non-Line Of Sight Bias Estimation

(71) Applicant: Alcatel-Lucent USA Inc., Murray Hill, NJ (US)

(72) Inventors: Fernando Perez-Cruz, New York, NY (US); Howard Huang, New York, NY (US)

(73) Assignee: Alcatel-Lucent USA Inc., Murray Hill, NJ (US)

(21) Appl. No.: 14/706,339

(22) Filed: May 7, 2015

(51) Int. Cl. G01S 5/02; H04W 24/06; G01S 5/14

(52) U.S. Cl. CPC G01S 5/0215; G01S 5/14; H04W 24/06

(57) ABSTRACT

Various embodiments provide a method and apparatus for determining non-line of sight (NLOS) bias estimation based on estimated NLOS bias distributions at a number of anchors and the time of arrival (ToA) of a number of tag messages received at the anchors. In particular, using anchor redundancy, tag locations corresponding to the tag messages are estimated based on the NLOS bias distributions and the ToA and then the tag locations are used to update the NLOS bias distributions. The process of determining tag locations and updating the NLOS bias distributions is repeated until the NLOS bias distributions converge.

### TECHNICAL FIELD

The invention relates generally to methods and apparatus for determining non-line of sight bias estimation.

### BACKGROUND

This section introduces aspects that may be helpful in facilitating a better understanding of the inventions. Accordingly, the statements of this section are to be read in this light and are not to be understood as admissions about what is in the prior art or what is not in the prior art.

In some known localization schemes, determination of non-line of sight (NLOS) bias is estimated using an assumed NLOS bias distribution. A second known localization scheme assumes a sufficient number of anchors are line of sight with the tag being localized. Finally, a third known localization scheme uses multipath time and received signal strength measurements to estimate the bias.

### SUMMARY OF ILLUSTRATIVE EMBODIMENTS

Some simplifications may be made in the following summary, which is intended to highlight and introduce some aspects of the various exemplary embodiments, but such simplifications are not intended to limit the scope of the inventions. Detailed descriptions of a preferred exemplary embodiment adequate to allow those of ordinary skill in the art to make and use the inventive concepts will follow in later sections

Various embodiments provide a method and apparatus for determining non-line of sight (NLOS) bias estimation based on estimated NLOS bias distributions at a number of anchors and the time of arrival (ToA) of a number of tag messages received at the anchors. In particular, using anchor redundancy, tag locations corresponding to the tag messages are estimated based on the NLOS bias distributions and the ToA and then the tag locations are used to update the NLOS bias distributions. The process of determining tag locations and updating the NLOS bias distributions is repeated until the NLOS bias distributions converge.

In a first embodiment, an apparatus is provided for providing an NLOS bias distribution. The apparatus includes a data storage and a processor communicatively connected to the data storage. The processor being programmed to: determine a plurality of non-line of sight (NLOS) bias distributions corresponding to a plurality of anchors; determine a plurality of time of arrival values associated with reception of a plurality of tag messages at a plurality of participating anchors, the plurality of anchors comprising the plurality of participating anchors; wherein the plurality of participating anchors have a corresponding plurality of anchor locations; estimate a plurality of estimated tag locations based on the plurality of time of arrival values, the plurality of NLOS bias distributions and the plurality of participating anchors; determine a plurality of NLOS biases based on the plurality of estimated tag locations, the plurality of anchor locations, and the plurality of time of arrival values; and update the plurality of NLOS bias distributions based on the plurality of NLOS biases.

In a second embodiment, a method is provided for providing an NLOS bias distribution. The method includes: determining a plurality of non-line of sight (NLOS) bias distributions corresponding to a plurality of anchors; determining a plurality of time of arrival values associated with reception of a plurality of tag messages at a plurality of participating anchors, the plurality of anchors comprising the plurality of participating anchors; wherein the plurality of participating anchors have a corresponding plurality of anchor locations; estimating a plurality of estimated tag locations based on the plurality of time of arrival values, the plurality of NLOS bias distributions and the plurality of participating anchors; determining a plurality of NLOS biases based on the plurality of estimated tag locations, the plurality of anchor locations, and the plurality of time of arrival values; and updating the plurality of NLOS bias distributions based on the plurality of NLOS biases.

In a third embodiment, a system is provided for providing an NLOS bias distribution. The system includes a tracking server and a plurality of participating anchors communicatively connected to the tracking server. The tracking server is configured to: determine a plurality of non-line of sight (NLOS) bias distributions corresponding to a plurality of anchors; determine a plurality of time of arrival values associated with reception of a plurality of tag messages at a plurality of participating anchors, the plurality of anchors comprising the plurality of participating anchors; wherein the plurality of participating anchors have a corresponding plurality of anchor locations; estimate a plurality of estimated tag locations based on the plurality of time of arrival values, the plurality of NLOS bias distributions and the plurality of participating anchors; determine a plurality of NLOS biases based on the plurality of estimated tag locations, the plurality of anchor locations, and the plurality of time of arrival values; and update the plurality of NLOS bias distributions based on the plurality of NLOS biases. The plurality of participating anchors have a common time reference and are configured to: determine a corresponding plurality of time of arrival values associated with reception of the plurality of tag messages based on the common time reference, the plurality of time of arrival values comprising the corresponding plurality of time of arrival values; and transmit the corresponding plurality of time of arrival values to the tracking server.

In a fourth embodiment, a non-transitory computer-readable storage medium for providing an NLOS bias distribution is provided. The storage medium includes instructions which, when executed by a computer, cause the computer to perform a method comprising: determining a plurality of non-line of sight (NLOS) bias distributions corresponding to a plurality of anchors; determining a plurality of time of arrival values associated with reception of a plurality of tag messages at a plurality of participating anchors, the plurality of anchors comprising the plurality of participating anchors; wherein the plurality of participating anchors have a corresponding plurality of anchor locations; estimating a plurality of estimated tag locations based on the plurality of time of arrival values, the plurality of NLOS bias distributions and the plurality of participating anchors; determining a plurality of NLOS biases based on the plurality of estimated tag locations, the plurality of anchor locations, and the plurality of time of arrival values; and updating the plurality of NLOS bias distributions based on the plurality of NLOS biases.

In some of the above embodiments, the embodiment further includes: determining a second plurality of time of arrival values associated with reception of a second tag message; and determining a second location associated with the second tag message based on the NLOS bias distributions and the second plurality of time of arrival values.

In some of the above embodiments, the plurality of NLOS bias distributions are based on a convex hull defined by the plurality of anchors.

In some of the above embodiments, the plurality of NLOS bias distributions are based on a mixture of Gaussians.

In some of the above embodiments, the determination of the plurality of time of arrival values includes retrieving the plurality of time of arrival values from a plurality of corresponding messages received from the plurality of participating anchors.

In some of the above embodiments, the estimation of the estimated tag locations includes determining a second estimated tag location based on a plurality of second time of arrival values corresponding to all but one of the participating anchors. Where the plurality of time of arrival values comprises the plurality of second time of arrival values; and the plurality of estimated tag locations comprises the second estimated tag location.

In some of the above embodiments, the embodiment includes determining a second NLOS bias based on the second estimated tag location. Where the plurality of NLOS biases comprises the second NLOS bias.

In some of the above embodiments, the plurality of time of arrival values are collected over a period of time, the period of time being based on one or more environmental conditions.

In some of the above embodiments, the plurality of participating anchors are further configured to: transmit a plurality of anchor identifiers corresponding to the corresponding plurality of time of arrival values to the tracking server.

### BRIEF DESCRIPTION OF THE DRAWINGS

Various embodiments are illustrated in the accompanying drawings, in which:

FIG. 1 illustrates a tag location network that includes an embodiment of a system 100 for providing determination of NLOS bias distribution;

FIG. 2 depicts a flow chart illustrating an embodiment of a method 200 for an apparatus (e.g., tracking server 130 of FIG. 1) to determine a tag's (e.g., tag 110 of FIG. 1) location based on NLOS bias estimation;

FIG. 3 illustrates a tag location network that includes an embodiment of determining a tag location corresponding to the tag message;

FIG. 4 depicts a flow chart illustrating an embodiment of a method 400 for an apparatus (e.g., tracking server 130 of FIG. 1) to determine a NLOS bias distribution as illustrated in step 220 of FIG. 2;

FIG. 5 illustrates an exemplary initial bias distribution 500 for an exemplary anchor (e.g., one of anchors 120 of FIG. 1);

FIG. 6 illustrates an exemplary updated bias distribution 600 for an exemplary anchor (e.g., one of anchors 120 of FIG. 1);

FIG. 7A illustrates exemplary source code 800A for initializing variables in Eq. 3;

FIG. 7B illustrates exemplary source code 700B for performing the algorithm of Eq. 3 to determine \hat{x} (the estimated tag location) and τ (the unknown time that the tag message was transmitted by the tag);

FIG. 8A illustrates exemplary source code 800A for initializing variables in Eq. 4;

FIG. 8B illustrates exemplary source code 800B for performing the algorithm of Eq. 4 and saving the determined NLOS bias distributions in an estimated model;

FIG. 8C illustrates exemplary source code 800C for adding a second Gaussian in a mixed Gaussian model to Eq. 4; and

FIG. 9 schematically illustrates an embodiment of an apparatus 900 such as one of anchors 120 or tracking server 130 of FIG. 1.

To facilitate understanding, identical reference numerals have been used to designate elements having substantially the same or similar structure or substantially the same or similar function.

### DETAILED DESCRIPTION OF ILLUSTRATIVE EMBODIMENTS

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Additionally, the term, “or,” as used herein, refers to a non-exclusive or, unless otherwise indicated (e.g., “or else” or “or in the alternative”). Also, the various embodiments described herein are not necessarily mutually exclusive, as some embodiments can be combined with one or more other embodiments to form new embodiments.

Various embodiments provide a method and apparatus for determining non-line of sight (NLOS) bias estimation based on estimated NLOS bias distributions at a number of anchors and the time of arrival (ToA) of a number of tag messages received at the anchors. In particular, using anchor redundancy, tag locations corresponding to the tag messages are estimated based on the NLOS bias distributions and the ToA and then the tag locations are used to update the NLOS bias distributions. The process of determining tag locations and updating the NLOS bias distributions is repeated until the NLOS bias distributions converge.

Advantageously, the determination of the NLOS bias distributions does not require knowledge of actual tag locations and therefore may be implemented with low overhead. Moreover, the determination is tolerant to uncertainty, provides 3D estimation, provides improved reliability over solutions such as those using iBeacons, works indoors, and does not require a specific infrastructure.

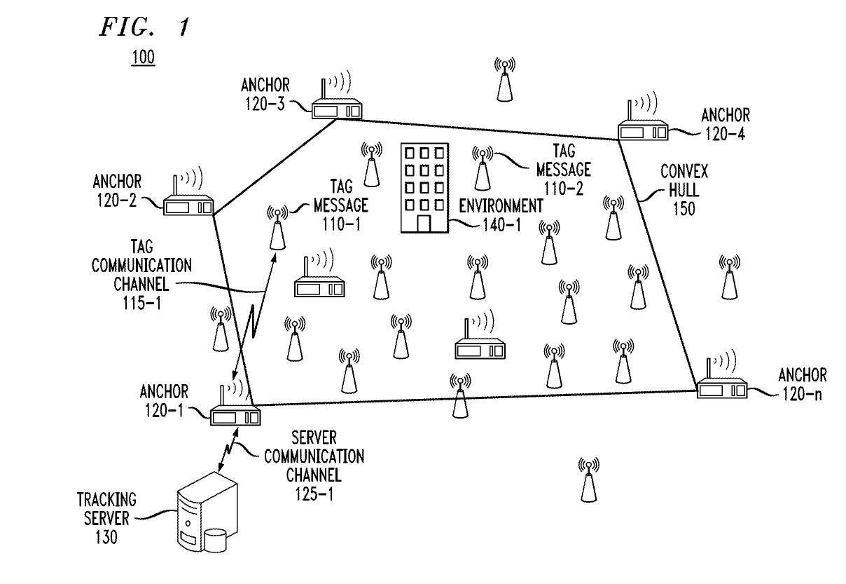

FIG. 1 illustrates a tag location network that includes an embodiment of a system 100 for providing determination of NLOS bias distribution. The system 100 includes appropriate ones of tag messages (collectively, tag messages 110) such as tag messages 110-1 and 110-2 transmitted over a period of time to five or more anchors 120-1-120-n (collectively, anchors 120) over an appropriate one or more of tag communication channels such as tag communication channel 115-1 (collectively, tag communication channels 115). Where tag communication channels 115 are subject to environmental conditions such as environment 140-1. Appropriate ones of anchors 120 communicate with tracking server 130 over an appropriate one or more of server communication channels such as server communication channel 125-1 (collectively, server communication channels 125). It should be appreciated that for purposes of clarity, all of the tag messages 110 and anchors 120 are not labeled. Furthermore, for purposes of clarity, all of tag communication channels 115 and server communication channels 125 are not illustrated.

Tag messages 110 may include any type of message delivered by a tag over a period of time. A tag (not illustrated for purposes of clarity) may be any type of communication device(s) capable of sending a wireless signal (e.g., a tag message) over one or more of tag communication channels 115. One or more tag messages may be delivered by the same tag over the period of time. For example, tag message 110-1 may be delivered by a tag at time (t) and tag message 110-2 may be delivered by the same tag at time (t+1). The period of time may be any appropriate interval. It should be appreciated that while nineteen (19) tag messages are illustrated here, system 100 may include more tag messages. It should be appreciated that though described herein in the context of RF transmissions, a tag message may be any wave phenomena such as ultrasound or low-frequency sonar.

Anchors 120 may include any type of communication device(s) capable of receiving tag messages 110 over and an appropriate one of tag communication channels 115, determining a time of arrival (ToA) of the tag message, and transmitting the ToA information and information identifying the tag message to server 130 via an appropriate one of server communication channels 125. In particular, participating anchors 120 must have stable clocks that are synchronized with each other or tracking server 130. Information identifying the tag message may be any suitable information enabling tracking server 130 to associate the ToA information with the corresponding tag message such as: (i) an identifier of the tag such as a tag id; (ii) an identifier of the tag message such as a tag message id; (iii) a timestamp; or (iv) the like.

In some embodiments, the anchor device is embedded in a communication device such as a thin client, a smart phone, a personal or laptop computer, server, network device, tablet, television set-top box, media player, automobile or the like. Communication devices may rely on other resources within exemplary system to perform a portion of tasks, such as processing or storage, or may be capable of independently performing tasks. It should be appreciated that while seven anchors are illustrated here, system 100 may include fewer or more anchors. However, the system requires at least five anchors. Moreover, the number of anchors at any one time may be dynamic as anchors may be added or subtracted from the system at various times during operation.

Tag communication channels 115 may be any suitable wireless connection capable of propagating tag messages 110 generated by a tag to one or more of anchors 120 such as radio frequency, ultrasonic, or visible light signals. It should be appreciated that though depicted as a single connection, communication channels 115 may be any number or combinations of communication channels.

Server communication channels 125 support communicating over one or more communication channels such as: wireless communications (e.g., LTE, GSM, CDMA, Bluetooth); WLAN communications (e.g., WiFi); packet network communications (e.g., IP); broadband communications (e.g., DOCSIS and DSL); storage communications (e.g., Fibre Channel, iSCSI) and the like. It should be appreciated that though depicted as a single connection, communication channels 125 may be any number or combinations of communication channels.

Tracking server 130 may be any apparatus capable of communicating over one or more appropriate server communication channels 125 and determining the NLOS bias distribution and the location of one or more of tag messages 110 based on the anchor message(s) received from one or more of anchors 120. In particular, tracking server 130 determines the NLOS bias estimation for each of participating anchors 120 based on estimated NLOS bias distributions and ToA of a number of tag messages 110 received at the anchors by determining tag locations corresponding to the tag messages based on the NLOS bias distributions and the ToAs and then the tag locations are used to update the NLOS bias distributions. The process of determining tag locations and updating the NLOS bias distributions is repeated until the NLOS bias distributions converge. It should be appreciated that while only one tracking server is illustrated here, system 100 may include more tracking servers. It should be further appreciated though depicted as communicating with anchors 120 via server communication channels 125, tracking server 130 may communicate with anchors 120 through any suitable communication network or may reside in the same device as one or more of anchors 120.

The tag message environment includes one or more environmental conditions such as environment 140-1 that impact the line of sight between a tag transmitting a tag message (e.g., tag message 110-1) and the anchor receiving the tag message (e.g., anchor 120-4). Environmental conditions may be any suitable condition such as: (i) buildings; (ii) office furniture; (iii) walls; (iv) vegetation (e.g., trees); or (v) the like.

In some embodiments, tag messages 110 are within a convex hull (e.g., convex hull 150) defined by the participating anchors (e.g., anchors 120). It should be appreciated, that by constraining tag messages within the convex hull defined by the anchors, performance may be improved as the anchors may be advantageously placed and environmental conditions may be tracked or controlled. In some of these embodiments, the anchors are placed within an establishment such as a building, store or office space.

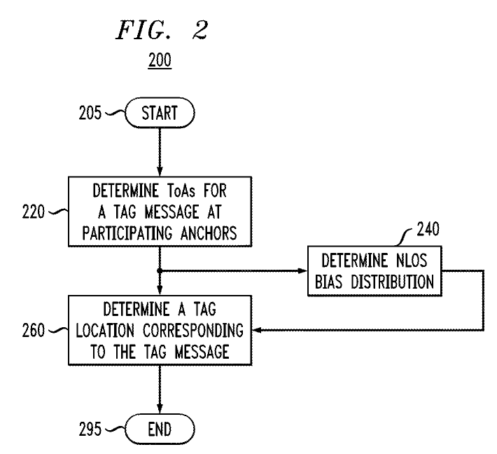

FIG. 2 depicts a flow chart illustrating an embodiment of a method 200 for an apparatus (e.g., tracking server 130 of FIG. 1) to determine a tag's (e.g., tag 110 of FIG. 1) location based on NLOS bias estimation. The method starts at step 205 and includes: determining ToAs for a tag message at participating anchors (step 220); determining an NLOS bias distribution (step 240); determining a tag location corresponding to the tag message (step 260); and ending at step 295.

In the method 200, the step 220 includes determining ToAs for a tag message at participating anchors. In particular, a tag transmits a tag message (e.g., tag message 110-1 of FIG. 1) which is received by five or more participating anchors (e.g., appropriates ones of anchors 120-3 of FIG. 1). Each of the participating anchors estimate the ToA of the tag message using a common time reference and transmits the ToA and optional attendant information to the tracking server (e.g., tracking server 130 of FIG. 1). The tracking server determines the ToAs by retrieving the appropriate information from the messages received from the anchors. Optional attendant information may be any suitable information such as information associated with the tag message as described herein or information associated with the anchor such as: (i) an identifier of the anchor such as an anchor id or IP address; (ii) actual location information (e.g., GPS coordinates); or (iii) the like. Information associated with tag message enables the tracking server to associate the ToA information with a particular tag message and information associated with the anchor enables the tracking server to associate the ToA with a particular anchor or anchor location.

In the method 200, the step 240 includes determining a NLOS bias distribution as described herein.

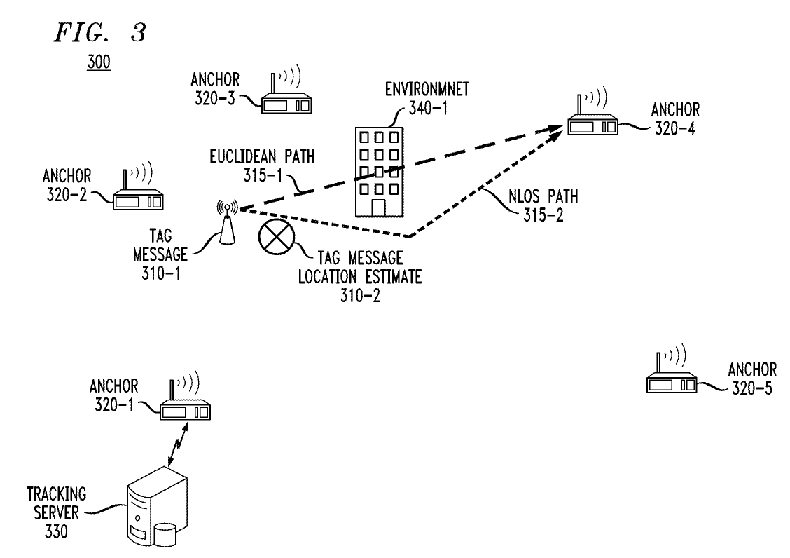

In the method 200, the step 260 includes determining a tag location corresponding to the tag message. In particular, the tag location is determined based on the NLOS bias distribution for each of the participating anchors and the ToA received from each of the participating anchors. In one embodiment, referring to FIG. 3, to linearize equations (1) and (2), the ToA of the tag message at five (5) or more anchors (e.g., anchors 320-1-320-5) and the NLOS bias distribution at those participating anchors are used to solve for x and τ (3D localization) (e.g., providing tag message location estimate 310-2). In this embodiment, the distribution of nⱼ is assumed to be a non-zero Gaussian.

ToAⱼ−τ=dⱼ/c+γⱼ+nⱼ (Eq. 1)

dⱼ=\sqrt{∥x−x̅ⱼ∥²} (Eq. 2)

where:
ToAⱼ=the ToA of the tag message at anchor j;
τ=the unknown time that the tag message was transmitted by the tag;
dⱼ=the distance of the Euclidean path between the tag and the anchor (e.g., Euclidean path 315-1 between tag message 310-1 and anchor 320-4);
c=the speed of light;
γⱼ=the NLOS bias between the tag and the anchor (e.g., the added bias to travel NLOS path 315-2 as compared to LOS path 315-1 due to environment 340-1 being in the LOS path of tag message 310-1 and anchor 320-4);
nⱼ=the noise error (e.g., clock error and ToA estimation error);
x=the unknown location of the tag transmitting the tag message (e.g., tag message 310-1); and
x̅ⱼ=the known location of the jth anchor (e.g., location of anchor 320-1).

In some embodiments of the step 260, the tag location is determined based on equation (3):

$$\hat{x} = \begin{matrix}argmax p ( x ) \\ x , τ\end{matrix} {\prod }_{j = 1}^{N} \frac{{p}_{j} ( {ToA}_{j} \vert τ , {d}_{j} , {σ}_{n} , Parameters )}{{d}_{j}} \qquad ( Eq . 3 )$$

where:
\hat{x}=the estimated tag location;
j=the anchor index;
N=the number of participating anchors;
pⱼ(ToAⱼ|τ,dⱼ,σₙ,Parameters)=the NLOS bias distribution for the jth anchor based on the ToA of a tag message sent at time ti over the distance dⱼ and standard deviation of σₙ with optional parameters; and
dⱼ=the distance of the Euclidean path between the tag and the anchor (e.g., Euclidean path 315-1 between tag message 310-1 and anchor 320-4).

In some embodiments, σₙ² (i.e., the variance) instead of σₙ. In some embodiments, the parameters are vectors for describing a mixture of Gaussians. In some of these embodiments, the parameters are the mixing proportions (πⱼ) and the necessary moments (μⱼ). In some of these embodiments, πⱼ are the mixing proportions for each Gaussians, μⱼ the mean of each Gaussian and Vⱼ their variance.

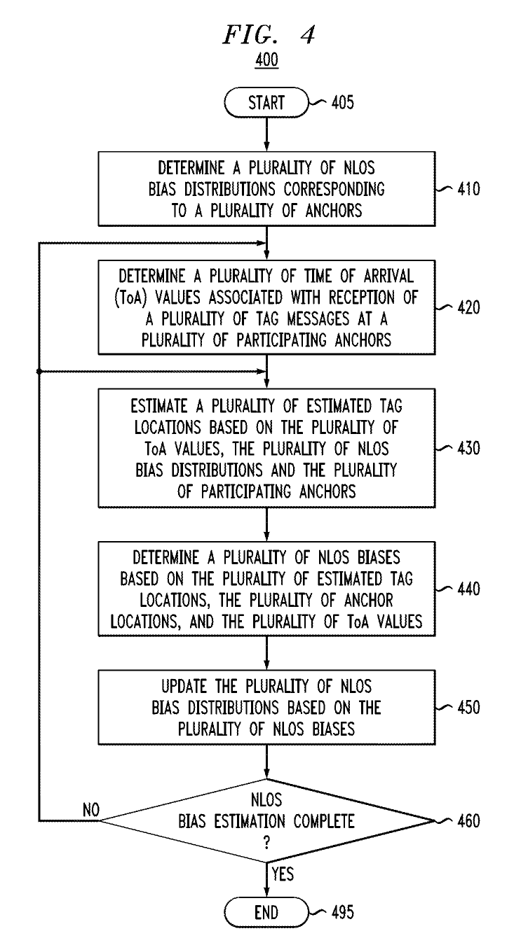

FIG. 4 depicts a flow chart illustrating an embodiment of a method 400 for an apparatus (e.g., tracking server 130 of FIG. 1) to determine a NLOS bias distribution as illustrated in step 220 of FIG. 2. The method starts at step 405 and includes: determining a plurality of NLOS bias distributions corresponding to a plurality of anchors (step 410); determining a plurality of ToA values associated with reception of a plurality of tag messages at a plurality of participating anchors (step 420); estimating a plurality of estimated tag locations based on the plurality of ToA values, the plurality of NLOS bias distributions and the plurality of participating anchors; (step 430); determining a plurality of NLOS biases based on the plurality of estimated tag locations, the plurality of anchor locations, and the plurality of ToA values (step 440); updating the plurality of NLOS bias distributions based on the plurality of NLOS Biases (step 450); and if the NLOS bias estimation is complete, proceeding to step 495 else returning to step 420 or step 430 (step 460); and ending at step 495.

In the method 400, the step 410 includes determining a plurality of NLOS bias distributions corresponding to a plurality of anchors (e.g., five or more of anchors 120 of FIG. 1 or anchors 320-1-320-5 of FIG. 3). In particular, an initial estimate of the bias distribution for a plurality of anchors is determined. Any suitable initial bias distribution may be used. In some embodiments, the initial distribution has an upper bound of greater or equal to twice the time required for a tag message to travel from the farthest point in the convex hull to the anchor. It should be appreciated that an initial bias distribution having an upper bound twice the time required may reduce potential NLOS biases. In some embodiments, the initial NLOS bias distribution comprises a mixture of Gaussians that are fit using a Hierarchical Diriclet Process. Referring to FIG. 5, an exemplary initial bias distribution 500 for an exemplary anchor (e.g., one of anchors 120 of FIG. 1) is shown where the NLOS bias distribution 510 is a Gaussian having an expected value of delay based on the time required for a tag message to travel from the farthest point in the convex hull to the anchor (i.e., μ=(Time_{MaxDistance})/2) and has a range from 0 (e.g., a tag message traveling a LOS path) to a delay equal to twice the time required for a tag message to travel from the farthest point in the convex hull to the anchor (e.g., (Time_{MaxDistance})).

In the method 400, the step 420 includes determining a plurality of ToA values associated with reception of a plurality of tag messages at a plurality of participating anchors as described herein, particularly as described in FIG. 1 and step 240 of FIG. 2. For example, referring to FIG. 3, tag message 310-1 is received by anchors 320-1-320-5 and each of these anchors determines a ToA associated with the reception of tag message 310-1 and forwards the ToA and optionally attendant information to tracking server 330. Similarly, tracking server 330 receives additional ToA values from anchors 320-1-320-5 associated with additional tag messages (not shown for purposes of clarity). In some embodiments, there are greater than 1,000 tag messages and greater than five (5) anchors. It should be appreciated that a larger number of anchors improves the determination of the bias distribution. It should also be appreciated that since tracking server 330 only requires five (5) participating anchors, not all anchors in the system are required to send ToA values or tracking server 330 may select ToAs from only a portion of the anchors for the method. For example, tracking server 330 may only select those ToAs coming from an anchor with a known location.

In the method 400, the step 430 includes estimating a plurality of estimated tag locations based on the plurality of ToA values, the plurality of NLOS bias distributions and the plurality of participating anchors as described herein, particularly as described in step 260 of FIG. 2. In particular, for each participating anchor j, the localization of the select portion of the plurality of tag messages is determined based on the ToAs from all of the participating anchors excluding the jth anchor. For example, referring to FIG. 3, to determine tag message location estimate 310-2 (e.g., the determined estimate location of tag message 310-1) at participating anchor 320-4, the ToAs of tag message 310-1 at anchors 320-1, 320-2, 320-3, and 320-5 are used. Similarly, a tag message location estimate for tag message 310-1 at anchor 320-1 would be based on ToAs of tag message 310-1 at anchors 320-2, 320-3, 320-4 and 320-5. Thus, a tag message location estimate for each tag message will be determined at each of the participating anchors using the ToAs of the tag message at the other anchors. It should be appreciated that localization of the tag messages may be done for any suitable subset including the entire set of tag messages.

In the method 400, the step 440 includes determining a plurality of NLOS biases based on the plurality of estimated tag locations, the plurality of anchor locations, and the plurality of ToA values. In particular, the NLOS bias is based on the relationship between the ToA of the tag message at the anchor and the distance between the tag and the anchor. In some embodiments, the NLOS bias is determined based on equation (4):

γ [symbol] =(ToAₜⱼ− [symbol] −(\sqrt{∥ [symbol] −x̅ⱼ∥²})/c (Eq. 4)
where:
[symbol] =the NLOS bias of the t^{th} tag message at the j^{th} anchor and [symbol] j symbolizes that the determination was based on ToAs from the tag message at all of the anchors except the j^{th} anchor;
ToAₜⱼ=the ToA of the t^{th} tag message at the j^{th} anchor;
[symbol] =the estimated transmission time of the tag transmitting the t^{th} tag message with reference to the j^{th} anchor clock from step 430 and [symbol] j symbolizes that the determination was based on ToAs from the tag message at all of the anchors except the j^{th} anchor;
[symbol] =the estimated location of the tag transmitting the t^{th} tag message from step 430 and [symbol] j symbolizes that the location determination was based on ToAs from the tag message at all of the anchors except the j^{th} anchor;
x̅ⱼ=the known location of the j^{th} anchor; and
c=the speed of light.

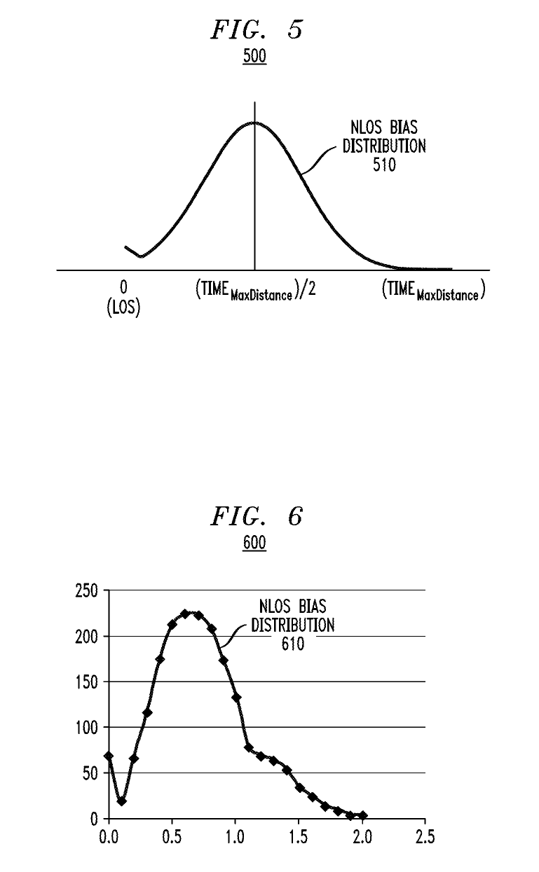

In the method 400, the step 450 includes updating the plurality of NLOS bias distributions based on the plurality of NLOS Biases determined in step 440. Any suitable model for updating the bios distribution may be used. For example, referring to FIGS. 5 and 6, NLOS bias distribution 610 represents the count of NLOS biases for a range of bios values (e.g., 0-2.0) determined in step 440 for a particular anchor. The initial bias distribution 510 may be updated to reflect NLOS bias distribution 610.

In the method 400, the step 460 includes proceeding to step 495 if the NLOS bias estimation is complete or returning to step 420 or step 430 if the NLOS bias estimation is not complete. NLOS bias estimation completion may be determined using any suitable method such as: (i) when the prior NLOS bias distribution and the updated NLOS bias distribution are within a threshold tolerance of each other; (ii) when the method has performed a threshold count of iterations; (iii) after a received tag message has been processed; or (iv) the like. The method may proceed to step 420 or 430 as appropriate. For example, when converging on bias distributions for a fixed set of ToAs values, the method may proceed to step 430 while if the method is collecting ToAs over time, the method may proceed to step 420. In some embodiments, step 460 proceeds to step 420 for some iterations and to step 430 for other iterations.

In some embodiments of the step 420, the ToA estimate is determined using conventional round trip time of arrival techniques. For example, suppose a tag sending tag message 310-1 of FIG. 3 sends a signal which is received and processed by anchor 320-4 of FIG. 3 which in turn sends a signal to the tag. If the processing delay at anchor 320-4 is known by the tag, then the tag may determine the time-of-flight by subtracting this delay from the round-trip time and dividing by 2. Similarly, an anchor may send a signal to the tag and receive a signal in return and determine the ToA by subtracting out the processing delay at the tag and dividing by two. In some embodiments, the processing delay is assumed to be zero.

In some embodiments of the step 420, the ToA is measured by the tag based on a signal received from the anchors. In some of these embodiments, the tag communicates the determined ToA directly to the tracking server (e.g., tracking server 130 of FIG. 1). In some of these embodiments, the tag communicates the determined ToA to the appropriate anchor.

In a first embodiment of the step 440, the ToA values are collected over a period of time. In some of these first embodiments, the period of time increases over the life of operation. In some of these embodiments, the period of time is a sliding window of a fixed size (e.g., one week). In some of these first embodiments, the period of time is based on the environment. In some of these embodiments, when a change in the environment occurs, the period of time adjusts. For example, if a new building is erected or new office cubicles are installed. In some of these embodiments, the system triggers a change in environment action based on a comparison of tag messages prior to a point in time and tag messages after a point in time.

In some embodiments of the step 440, the NLOS bias distribution for an anchor has a uniform distribution. In some embodiments, the NLOS bias distribution for an anchor is distributed based on the estimated direction of the tag sending the tag message. For example, an LTE system having three sectors may use three distributions associated with the particular sector antenna receiving the tag message. In another example, the estimated direction of the tag sending the tag message may be estimated based on the ToAs of the anchors (e.g., an anchor receiving the tag message fastest may be assumed to be closer to the tag than an anchor receiving the tag message at a later time).

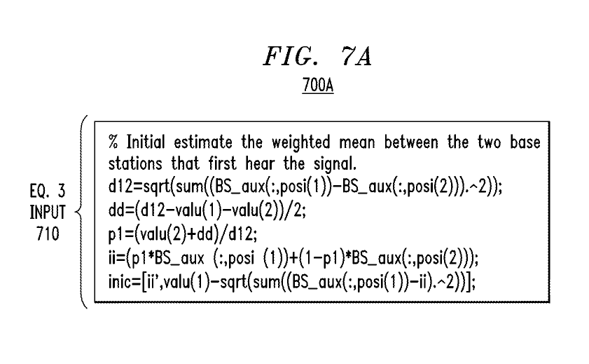

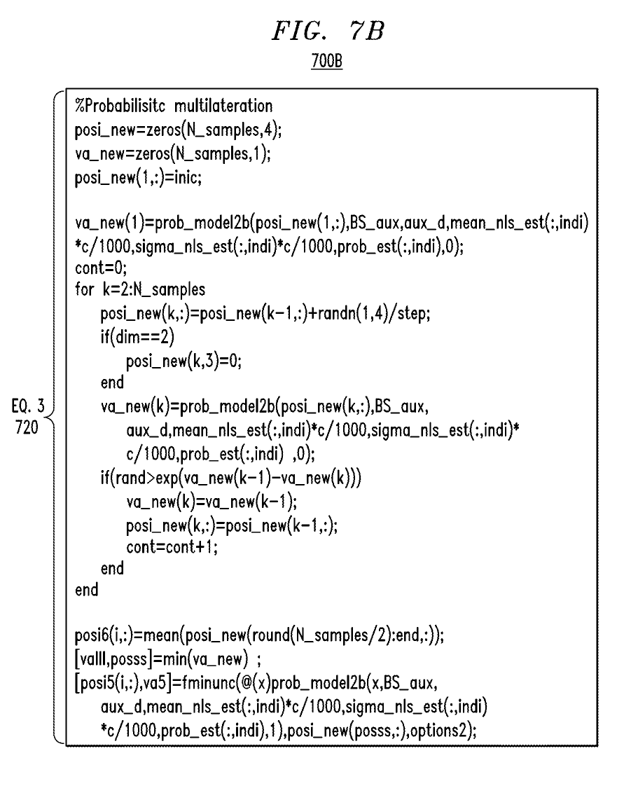

In some embodiments, Eq. 3 is implemented in exemplary source code as described in FIGS. 7A and 7B where Eq. 3 input 710 initializes variables and Eq. 3 710 performs the algorithm of Eq. 3 to determine \hat{x} (the estimated tag location) and τ (the unknown time that the tag message was transmitted by the tag).

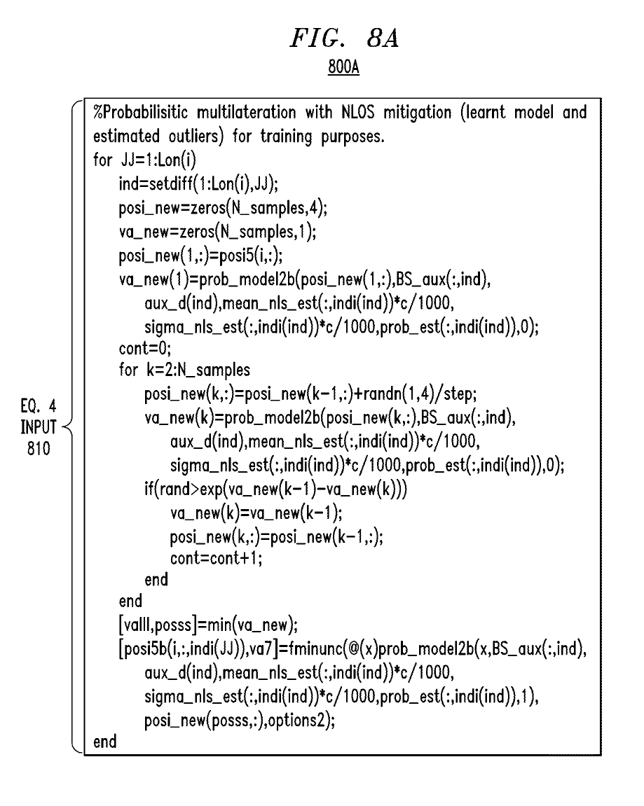

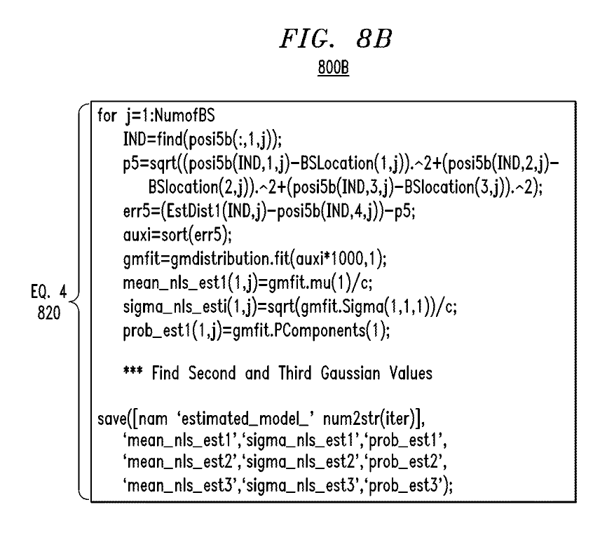

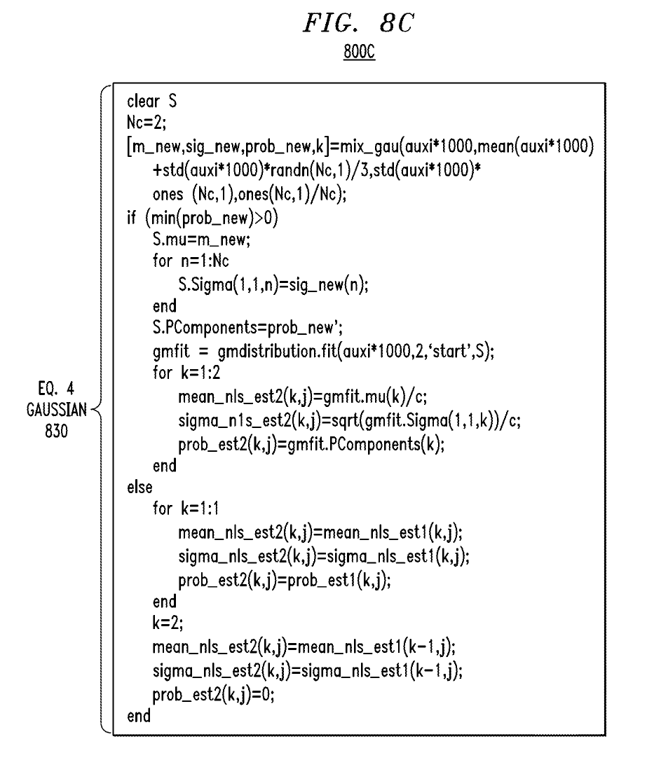

In some embodiments, Eq. 4 is implemented in exemplary source code as described in FIGS. 8A, 8B and 8C where Eq. 4 input 810 initializes variables, Eq. 4 710 performs the algorithm of Eq. 4 and saves the determined NLOS bias distributions in an estimated model, and Eq. 4 Gaussian 830 illustrates source code for adding a second Gaussian in a mixed Gaussian model to Eq. 4. It should be appreciated that Eq. 4 Gaussian 830 may be repeated over a number of parameters to mix additional Gaussians or any other distribution.

The inventors have found that the improvements in reducing NLOS bias in a localization system having six (6) anchors (e.g., such as system 100 of FIG. 1) has achieved greater than three (3) times improvement in localization accuracy for LTE channel models. The exemplary embodiments of FIGS. 7A, 7B, 8A, 8B and 8C were used to achieve the aforementioned improved accuracy.

Although primarily depicted and described in a particular sequence, it should be appreciated that the steps shown in methods 200 and 400 may be performed in any suitable sequence. Moreover, the steps identified by one step may also be performed in one or more other steps in the sequence or common actions of more than one step may be performed only once. For example, steps 420, 430 and 440 of FIG. 4 may be performed for a number of iterations for received ToA values associated with one or more tag messages before the NLOS bias distributions are updated in step 450. Referring to FIG. 2, ToA values for a tag message may be received and used to i) determine a tag location (e.g., step 260); and ii) determine an NLOS bias distribution (e.g., step 240) by way of determining ToA values for a tag message (e.g., step 420 of FIG. 4) and updating the NLOS bias distributions (e.g., step 450 of FIG. 4). It should be appreciated that the NLOS bias distributions may not be updated for each determined ToA in step 220 and may be updated during any suitable time. For example, step 450 may be performed: i) after a number of ToAs have been determined; ii) during a period when resources are available; iii) when scheduled (e.g., to update during evening hours); iv) when a trigger event occurs; or v) the like.

It should be appreciated that steps of various above-described methods can be performed by programmed computers. Herein, some embodiments are also intended to cover program storage devices, e.g., data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable data storage media. The embodiments are also intended to cover computers programmed to perform said steps of the above-described methods.

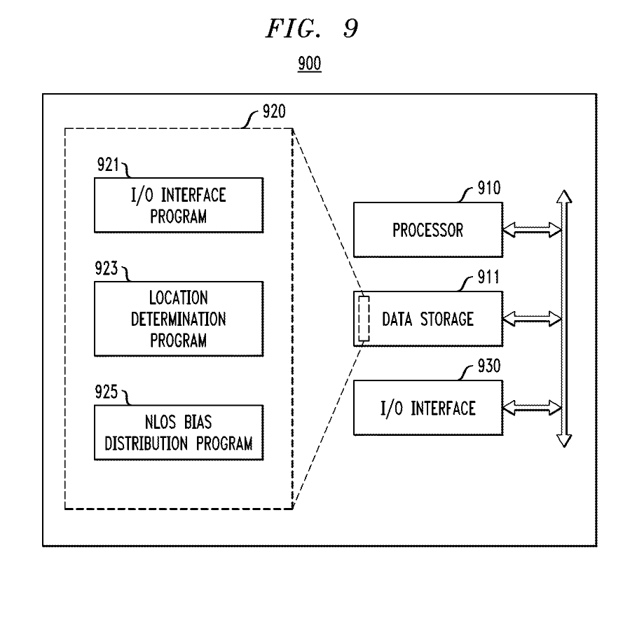

FIG. 9 schematically illustrates an embodiment of an apparatus 900 such as one of anchors 120 or tracking server 130 of FIG. 1. The apparatus 900 includes processor 910, data storage 911, and I/O interface 930.

The processor 910 controls the operation of the apparatus 900. The processor 910 cooperates with the data storage 911.

The data storage 911 stores appropriate ones of programs 920 executable by the processor 910. Data storage 911 may also optionally store program data such as NLOS bias distributions, ToA values or the like as appropriate.

The processor-executable programs 920 may include an I/O interface program 921, a location determination program 923, or a NLOS bias distribution program 925. Processor 910 cooperates with processor-executable programs 920.

The I/O interface 930 cooperates with processor 910 and I/O interface program 921 to support communications over communication channels 115 or 125 of FIG. 1 as appropriate and as described above.

The location determination program 923 performs the steps of FIG. 2 or step 430 of FIG. 4 as appropriate and as described above.

The NLOS bias distribution program 925 performs steps of FIG. 4 as described above.

In some embodiments, the processor 910 may include resources such as processors/CPU cores, the I/O interface 930 may include any suitable network interfaces, or the data storage 911 may include memory or storage devices. Moreover the apparatus 900 may be any suitable physical hardware configuration such as: one or more server(s), blades consisting of components such as processor, memory, network interfaces or storage devices. In some of these embodiments, the apparatus 900 may include cloud network resources that are remote from each other.

In some embodiments, the apparatus 900 may be virtual machine. In some of these embodiments, the virtual machine may include components from different machines or be geographically dispersed. For example, the data storage 911 and the processor 910 may be in two different physical machines.

When processor-executable programs 920 are implemented on a processor 910, the program code segments combine with the processor to provide a unique device that operates analogously to specific logic circuits.

Although depicted and described herein with respect to embodiments in which, for example, programs and logic are stored within the data storage and the memory is communicatively connected to the processor, it should be appreciated that such information may be stored in any other suitable manner (e.g., using any suitable number of memories, storages or databases); using any suitable arrangement of memories, storages or databases communicatively connected to any suitable arrangement of devices; storing information in any suitable combination of memory(s), storage(s) or internal or external database(s); or using any suitable number of accessible external memories, storages or databases. As such, the term data storage referred to herein is meant to encompass all suitable combinations of memory(s), storage(s), and database(s).

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the FIGs., including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional or custom, may also be included. Similarly, any switches shown in the FIGS. are conceptual only. Their function may be carried out through the operation of program logic, through dedicated logic, through the interaction of program control and dedicated logic, or even manually, the particular technique being selectable by the implementer as more specifically understood from the context.

It should be appreciated that any block diagrams herein represent conceptual views of illustrative circuitry embodying the principles of the invention. Similarly, it should be appreciated that any flow charts, flow diagrams, state transition diagrams, pseudo code, and the like represent various processes which may be substantially represented in computer readable medium and so executed by a computer or processor, whether or not such computer or processor is explicitly shown.

What is claimed is:

1. An apparatus for providing an NLOS bias distribution, the apparatus comprising:
a data storage; and
a processor communicatively connected to the data storage, the processor being configured to:
determine a plurality of non-line of sight (NLOS) bias distributions corresponding to a plurality of anchors;
determine a plurality of time of arrival values associated with reception of a plurality of tag messages at a plurality of participating anchors, the plurality of anchors comprising the plurality of participating anchors; wherein the plurality of participating anchors have a corresponding plurality of anchor locations;
estimate a plurality of estimated tag locations based on the plurality of time of arrival values, the plurality of NLOS bias distributions and the plurality of participating anchors;
determine a plurality of NLOS biases based on the plurality of estimated tag locations, the plurality of anchor locations, and the plurality of time of arrival values; and
update the plurality of NLOS bias distributions based on the plurality of NLOS biases.

2. The apparatus of claim 1, wherein the processor is further configured to:
determine a second plurality of time of arrival values associated with reception of a second tag message; and
determine a second location associated with the second tag message based on the NLOS bias distributions and the second plurality of time of arrival values.

3. The apparatus of claim 1, wherein the plurality of NLOS bias distributions are based on a convex hull defined by the plurality of anchors.

4. The apparatus of claim 1, wherein the plurality of NLOS bias distributions are based on a mixture of Gaussians.

5. The apparatus of claim 1, wherein the determination of the plurality of time of arrival values comprises configuring the processor to retrieve the plurality of time of arrival values from a plurality of corresponding messages received from the plurality of participating anchors.

6. The apparatus of claim 1, wherein the estimation of the estimated tag locations comprises configuring the processor to:
determine a second estimated tag location based on a plurality of second time of arrival values corresponding to all but one of the participating anchors;
wherein the plurality of time of arrival values comprises the plurality of second time of arrival values; and
wherein the plurality of estimated tag locations comprises the second estimated tag location.

7. The apparatus of claim 6, wherein the processor is further configured to:
determine a second NLOS bias based on the second estimated tag location;
wherein the plurality of NLOS biases comprises the second NLOS bias.

8. The apparatus of claim 1, wherein the plurality of time of arrival values are collected over a period of time, the period of time being based on one or more environmental conditions.

9. A system for providing an NLOS bias distribution, the system comprising:
a tracking server, the tracking server configured to:
determine a plurality of non-line of sight (NLOS) bias distributions corresponding to a plurality of anchors;
determine a plurality of time of arrival values associated with reception of a plurality of tag messages at a plurality of participating anchors, the plurality of anchors comprising the plurality of participating anchors; wherein the plurality of participating anchors have a corresponding plurality of anchor locations;
estimate a plurality of estimated tag locations based on the plurality of time of arrival values, the plurality of NLOS bias distributions and the plurality of participating anchors;
determine a plurality of NLOS biases based on the plurality of estimated tag locations, the plurality of anchor locations, and the plurality of time of arrival values; and
update the plurality of NLOS bias distributions based on the plurality of NLOS biases; and
the plurality of participating anchors, the plurality of participating anchors communicatively connected to the tracking server and having a common time reference and each being configured to:
determine a corresponding plurality of time of arrival values associated with reception of the plurality of tag messages based on the common time reference, the plurality of time of arrival values comprising the corresponding plurality of time of arrival values; and
transmit the corresponding plurality of time of arrival values to the tracking server.

10. The system of claim 9 wherein the plurality of participating anchors are further configured to:
transmit a plurality of anchor identifiers corresponding to the corresponding plurality of time of arrival values to the tracking server.

11. A method for providing an NLOS bias distribution, the method comprising:
at a processor communicatively connected to a data storage, determining a plurality of non-line of sight (NLOS) bias distributions corresponding to a plurality of anchors;
determining, by the processor in cooperation with the data storage, a plurality of time of arrival values associated with reception of a plurality of tag messages at a plurality of participating anchors, the plurality of anchors comprising the plurality of participating anchors; wherein the plurality of participating anchors have a corresponding plurality of anchor locations;
estimating, by the processor in cooperation with the data storage, a plurality of estimated tag locations based on the plurality of time of arrival values, the plurality of NLOS bias distributions and the plurality of participating anchors;
determining, by the processor in cooperation with the data storage, a plurality of NLOS biases based on the plurality of estimated tag locations, the plurality of anchor locations, and the plurality of time of arrival values; and
updating, by the processor in cooperation with the data storage, the plurality of NLOS bias distributions based on the plurality of NLOS biases.

12. The method of claim 11, wherein the method further comprises:
determining, by the processor in cooperation with the data storage, a second plurality of time of arrival values associated with reception of a second tag message; and
determining, by the processor in cooperation with the data storage, a second location associated with the second tag message based on the NLOS bias distributions and the second plurality of time of arrival values.

13. The method of claim 11, wherein the plurality of NLOS bias distributions are based on a convex hull defined by the plurality of anchors.

14. The apparatus of claim 11, wherein the plurality of NLOS bias distributions are based on a mixture of Gaussians.

15. The apparatus of claim 11, wherein the determining the plurality of time of arrival values comprises retrieving the plurality of time of arrival values from a plurality of corresponding messages received from the plurality of participating anchors.

16. The apparatus of claim 11, wherein estimating the estimated tag locations comprises:
determining a second estimated tag location based on a plurality of second time of arrival values corresponding to all but one of the participating anchors;
wherein the plurality of time of arrival values comprises the plurality of second time of arrival values; and
wherein the plurality of estimated tag locations comprises the second estimated tag location.

17. The apparatus of claim 16, wherein the method further comprises:
determining a second NLOS bias based on the second estimated tag location;
wherein the plurality of NLOS biases comprises the second NLOS bias.

18. The apparatus of claim 11, wherein the plurality of time of arrival values are collected over a period of time, the period of time being based on one or more environmental conditions.

19. A non-transitory computer-readable storage medium storing instructions which, when executed by a computer, cause the computer to perform a method, the method comprising:
determining a plurality of non-line of sight (NLOS) bias distributions corresponding to a plurality of anchors;
determining a plurality of time of arrival values associated with reception of a plurality of tag messages at a plurality of participating anchors, the plurality of anchors comprising the plurality of participating anchors; wherein the plurality of participating anchors have a corresponding plurality of anchor locations;
estimating a plurality of estimated tag locations based on the plurality of time of arrival values, the plurality of NLOS bias distributions and the plurality of participating anchors;
determining a plurality of NLOS biases based on the plurality of estimated tag locations, the plurality of anchor locations, and the plurality of time of arrival values; and
updating the plurality of NLOS bias distributions based on the plurality of NLOS biases.
